(19) United States
(12) Patent Application Publication
(10) Pub. No.: US 2010/0287392 A1
(43) Pub. Date: Nov. 11, 2010

(54) POWER SAVING CONTROL SYSTEM AND CONTROL METHOD

(75) Inventor: SHENG-CHIEH HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/477,873

(22) Filed: Jun. 3, 2009

(30) Foreign Application Priority Data
May 6, 2009 (CN) 200910302121.0

(51) Int. Cl. G06F 1/32

(52) U.S. Cl. 713/321

(57) ABSTRACT

A power saving control system includes a memory module, and a main controller. The memory module includes a number of memories. The main controller includes a detecting unit, a determining unit, and a management control unit. The detecting unit is to detect a usage rate of the memory module. The determining unit stores a number of interval parameters denoting a number of usage rate ranges of the memory module, and determine a corresponding interval parameter for the detected usage rate of the memory module. The management control unit stores a number of control instructions corresponding to the number of the interval parameters, and is to invoke a control instruction corresponding to the determined interval parameter, to control corresponding memories of the memory module to work.

### BACKGROUND

1. Technical Field

The present disclosure relates to control systems and control methods, and particularly to a power saving control system and a power saving control method.

2. Description of Related Art

With the development of electronic technology, power consumption of electronic devices is very important. Presently, computers may have a plurality of memory modules, which consume a lot of power. However, when the computer is idle or when not processing a lot of information, the memory modules are still kept in a working state, causing power to be wasted.

### BRIEF DESCRIPTION OF THE DRAWINGS

FIG. 1 is block diagram of an exemplary embodiment of a power saving control system.

FIG. 2 is a flowchart of an exemplary embodiment of a power saving control method of the power saving control system of FIG. 1.

### DETAILED DESCRIPTION

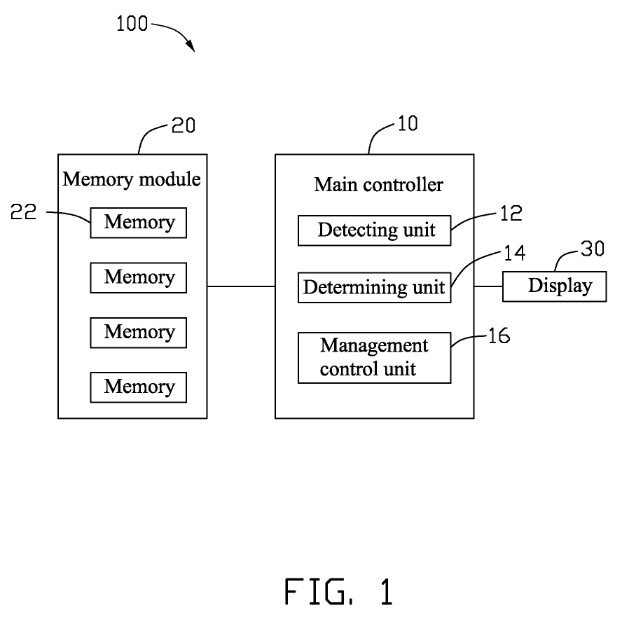

Referring to FIG. 1, an exemplary power saving control system 100 to save power used by an electronic device, such as a computer, includes a main controller 10, a memory module 20, and a display 30. The main controller 10 is connected between the memory module 20 and the display 30. The memory module 20 may include four physical memories 22, such as random access memory (RAM), for example. In other embodiments, the number of the memories 22 can be changed.

The main controller 10 includes a detecting unit 12, a determining unit 14, and a management control unit 16.

The detecting unit 12 detects a usage rate of the memory module 20, according to an amount of the memory module currently in use by the electronic device divided by the total available memory of the memory module.

The determining unit 14 stores first to fourth interval parameters corresponding to the usage rate of the memory module 20. For example, the first interval parameter denotes a first usage rate range of 0<X≦20%, where X denotes the usage rate of the memory module 20. The second interval parameter denotes a second usage rate range of 20%<X≦50%. The third interval parameter denotes a third usage rate range of 50%<X≦80%. The fourth interval parameter denotes a fourth usage rate range of 80%<X≦100%. The determining unit 14 determines a corresponding interval parameter for the detected usage rate of the memory module, in response to the usage rate of the memory module 20 being not equal to 0. It may be understood that the determining unit 14 may store other number of interval parameters depending on the embodiment.

The management control unit 16 stores first to fourth control instructions corresponding to the interval parameters. The first control instruction corresponds to the first interval parameter, to control one quarter of the memories 22 of the memory module 20 to work, namely control one memory 22 when there are four memories 22. The second control instruction corresponds to the second interval parameter, to control two quarters of the memories 22 of the memory module 20 to work and so on. The management control unit 16 invokes one control instruction corresponding to an interval parameter denoting the determined usage rate range, to control the corresponding memories 22 to work.

The display 30 displays a selecting interface on the display 30, allowing operators to control operation of the main controller 10 to control the memory module 22. When the main controller 10 is selected on the display 30, the main controller 10 controls the memories 22 to save power for the computer. When the main controller is not selected on the display 30, the power saving control system 1 is exited.

In other embodiments, the usage rate range and the number of the interval parameters can be changed according to the number of the memories 22, and the control instructions and the number of control instructions can be adjusted correspondingly. The number of memories controlled by the control instructions to work increases following increasing of a maximum value of a usage rate range denoted by the corresponding interval parameter. The memories 22 can also be replaced by other electrical elements such as processors. When the main controller 10 is started to save power without being selected via the display 30, the power saving control system 1 omits controlling the display 30 to display the selecting interface. The main controller 10 is started directly to save power when the computer is powered.

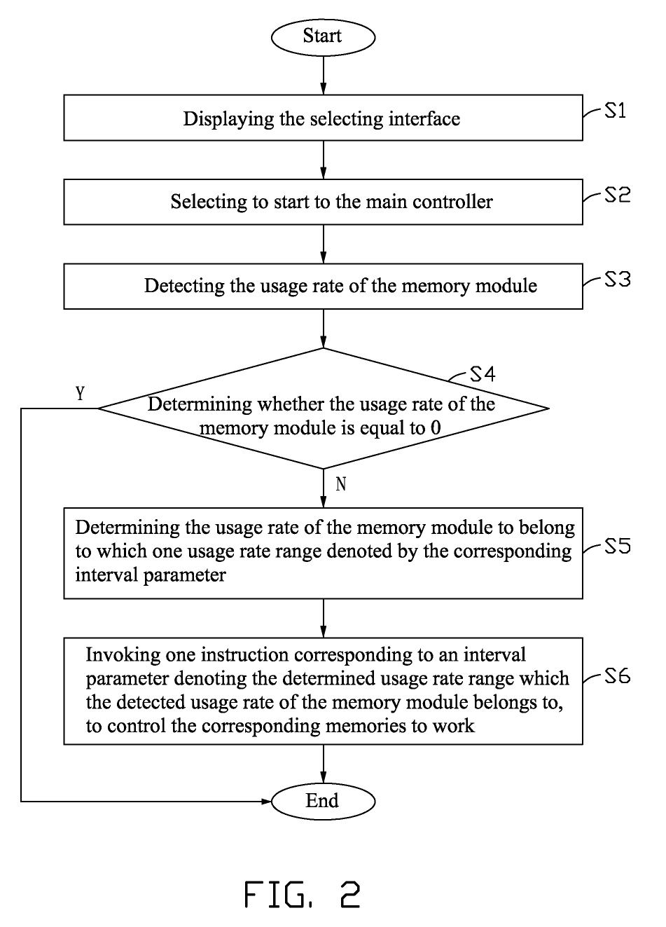

Referring to FIG. 2, an exemplary control method using the above-mentioned saving power control system 1 includes the following steps.

In step 1, the display 30 displays the selecting interface on the display 30;

In step 2, an operator selects to start the main controller 10 in the selecting interface, the main controller 10 is started to save power for the computer;

In step 3, the detecting unit 12 detects the usage rate of the memory module 20;

In step 4, the determining unit 14 determines whether the usage rate of the memory module 20 is equal to 0. If the usage rate of the memory module 20 is equal to 0, the power saving control system 1 is exited, and if the usage rate of the memory module is not equal to 0, the procedure goes to step 5;

In step 5, the determining unit 14 determines a corresponding interval parameter for the detected usage rate of the memory module; and

In step 6, the management control unit 16 invokes a control instruction corresponding to the determined interval parameter, to control the corresponding memories 22 to work.

For example, when the main controller 10 is selected to start, the detecting unit 12 detects the usage rate of the memory module 20. If the detected usage rate of the memory module 20 is 40%, the determining unit 14 determines the second interval parameter for the detected usage rate of the memory module 20. The management control unit 16 invokes the second control instruction corresponding to the second interval parameter to control two memories 22 to work.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A power saving control system for an electronic device, comprising:
a memory module; and
a main controller connected to the memory module, the main controller comprising:
a detecting unit to detect a usage rate of the memory module, according to an amount of the memory module currently in use by the electronic device divided by the total available memory of the memory module;
a determining unit storing a plurality of interval parameters denoting usage rate ranges of the memory module, the plurality of interval parameters corresponding to the usage rate ranges of the memory module, the determining unit to determine a corresponding interval parameter for the detected usage rate of the memory module; and
a management control unit storing a plurality of control instructions corresponding to the plurality of the interval parameters, to invoke a control instruction corresponding to the determined interval parameter, to control corresponding memories of the memory module to work.

2. The power saving control system of claim 1, wherein the number of memories controlled by the control instructions to work increases following an increase of a maximum value of a usage rate range denoted by the corresponding interval parameter.

3. The power saving control system of claim 1, further comprising a display connected the main controller, wherein the display displays a selecting interface for an operator to start the main controller to save power for the electronic device.

4. The power saving control system of claim 1, wherein the determining unit determines whether the detected usage rate of the memory module is equal to 0, and determines a corresponding interval parameter for the detected usage rate of the memory module, in response to the detected usage rate of the memory module is not equal to 0.

5. The power saving control system of claim 1, wherein the memory module comprises four memories.

6. The power saving control system of claim 1, wherein the determining unit stores first to fourth interval parameters, the first interval parameter denotes a first usage rate range of 0<X≦20%, the second interval parameter denotes a second usage rate range of 20%<X≦50%, the third interval parameter denotes a third usage rate range of 50%<X≦80%, the fourth interval parameter denotes a fourth usage rate range of 80%<X≦100%, wherein X denotes the usage rate of the memory module.

7. The power saving control system of claim 6, wherein the management control unit stores first to fourth control instructions, the first control instruction corresponds to the first interval parameter, to control one quarter of the memories of the memory module to work; the second control instruction corresponds to the second interval parameter, to control two quarter of the memories of the memory module to work; the third control instruction corresponds to the third interval parameter, to control three quarter of the memories of the memory module to work; the fourth control instruction corresponds to the fourth interval parameter, to control all memories of the memory module to work.

8. A power saving control method applied to an electronic device to save power, the power saving control method comprising:
detecting a usage rate of a memory module of the electronic device, according to an amount of the memory module currently in use by the electronic device divided by the total available memory of the memory module;
determining whether the detected usage rate of the memory module is equal to 0;
determining a corresponding interval parameter for the detected usage rate of the memory module, in response to the usage rate of the memory module is not equal to 0; and
invoking a control instruction corresponding to the determined interval parameter to control the corresponding memories of the memory module to work.

9. The power saving control method of claim 8, further comprising:
displaying a selecting interface on a display and selecting whether saving power before the step of detecting the usage rate of the memory module.

10. The power saving control method of claim 8, wherein there are first to fourth interval parameters denoting the usage rate range of the memory module, the first interval parameter denotes a first usage rate range of 0<X≦20%, the second interval parameter denotes a second usage rate range of 20%<X≦50%, the third interval parameter denotes a third usage rate range of 50%<X≦80%, the fourth interval parameter denotes a fourth usage rate range of 80%<X≦100%, wherein X denotes the usage rate of the memory module.

11. The power saving control method of claim 10, wherein there are first to fourth control instructions, the first control instruction corresponds to the first interval parameter, to control one quarter of the memories of the memory module to work; the second control instruction corresponds to the second interval parameter, to control two quarter of the memories of the memory module to work; the third control instruction corresponds to the third interval parameter, to control three quarter of the memories of the memory module to work; the fourth control instruction corresponds to the fourth interval parameter, to control all memories of the memory module to work.
